(19) United States
(12) Patent Application Publication
(10) Pub. No.: US 2005/0136954 A1
(43) Pub. Date: Jun. 23, 2005

(54) Entering information using terminals with limited I/O capabilities

(75) Inventor: Takeshi Itoh, Kawaguchi-shi (JP)

Correspondence Address: David R. Irvin;International Business Machines, Intellectual Property Law, Dept. TS1/Bldg. 503, P.O. Box 12195, Research Triangle Park, NC, 27709, US

(73) Assignee: International Business Machines Corporation, Armonk, NY (US)

(21) Appl. No.: 11/007,124

(22) Filed: Dec. 8, 2004

(30) Foreign Application Priority Data
Dec. 17, 2003 (JP) 2003-418969

(51) Int. Cl. H04Q 7/20

(52) U.S. Cl. 455/466; 455/412.1

(57) ABSTRACT

To enable quick selection of predefined text, there are provided a scenario information storage section for information that defines multiple predefined texts that are input candidates along with relationships between the predefined texts and a predefined text expected to be input next, an input section for accepting information input by an operation key, an output section for outputting a button having a predefined text as a label to an LCD, a receiving section for receiving a sent message, a sending section for sending a predefined text passed thereto, and a control section for passing a first predefined text defined by the scenario information as an input candidate to the output unit and to the sending section and passing a second predefined text, which is defined by the scenario information to be input following the first predefined text, as an input candidate.

### FIELD OF THE INVENTION

The present invention relates to method, apparatus, and computer program products for enabling quick input of information into terminals such as cellular telephones having limited I/O capabilities.

### BACKGROUND

In mobile terminals such as cellular telephones, it is difficult to input a text quickly because these devices typically have limited I/O capabilities such as input keys. Quick input is advantageous in real-time applications such as chat room sessions. Accordingly, phrases used frequently are commonly registered as predefined texts so that they can be processed quickly when encountered. For example, pushing a menu button while a text field is displayed may cause an input screen to be displayed. In this condition, by selecting “Paste Predefined text” to input a predefined text, and then selecting “User-defined text,” a second screen may be displayed from which the user may select a desired predefined text from among a plurality of predetermined user-defined texts displayed on the screen. In some PDAs (personal digital assistants), the options are displayed in a pull-down menu rather than in such a list.

In other situations, a predefined text may be input by pushing a numeral key corresponding to a group that includes a plurality of predefined texts, one of which texts is to be selected for input, where the key is pushed a number of times that corresponds to an identification number given to the desired predefined text in the group. Such a method is described in, for example, FIGS. 2 and 3 of Japanese Unexamined Patent Application No. 2000-270115.

In still other situations, it is possible to use predicted conversion with an Input Method Editor (IME), which is suitable not only for a particular application program but for all inputs on mobile equipment. If this is used, it is sufficient for the application program to provide a field into which a text can be entered.

Unfortunately, the aforementioned methods may increase the number of times a user must operate keys to input a desired predefined text. For example, in the first technique described above, the user has to use a key for moving a cursor upward (hereinafter referred to as the “upward key”), a key for moving the cursor downward (hereinafter referred to as the “downward key”) and a key for determining selection of an option where the cursor is positioned (hereinafter referred to as the “center key”) as necessary to select a desired predefined text.

In the technique disclosed in Japanese Unexamined Patent Application No. 2000-270115, the operation is somewhat simplified, and yet the problem of increased number of times the keys are operated has not been fully solved.

Even when the predicted conversion with IME is used, the number of times the keys are operated to input a desired predefined text cannot be greatly reduced. The IME is created for general purposes, and therefore a word the user wants may not necessarily be presented as the first candidate. Although the rank of a word used once is usually increased when it is selected next time, this method does not reduce the number of key operations in the case where a predefined text that is used once is seldom used again, such as in the case of a chat.

### SUMMARY

According to the present invention, a predefined text expected to be input next is displayed. A first input support apparatus of the present invention is provided with a storage section for storing scenario information that defines multiple predefined texts that are candidates to be input, along with relationships between each of the predefined texts and a predefined text expected to be input following the predefined text; and a display section for displaying a first predefined text that has been defined by the scenario information, as an input candidate, and subsequently, on the condition that input of the first predefined text has been determined, displaying a second predefined text as an input candidate defined by the scenario information to be input following the fist predefined text.

According to the present invention, an input candidate may be displayed on the label of a button to enable sending with one click. That is, in a second input support apparatus of the present invention, the display section of the first input support apparatus may display the first predefined text on a button that is an object on a screen and determines that input of the first predefined text has been selected by detecting the button being pushed.

Furthermore, the present invention can be regarded as a message sending apparatus for displaying a message expected to be sent next. In this case, the message sending apparatus of the present invention is provided with a display section for displaying a button to which message expected to be sent next is attached; and a sending section for, when the button displayed on the display section is pushed, sending the message attached to the button.

Furthermore, the present invention can be regarded as a user interface for sending a message. In this case the user interface of the present invention includes a button on which a message expected to be sent next is displayed as a label; and an area in which the message displayed on the button as a label is displayed when the button is pushed.

Furthermore, the present invention can be regarded as a method for displaying a predefined text expected to be input next on the label of a button to enable sending with one click. In this case, the input support method of the present invention includes: displaying a first predefined text as an input candidate on a button that is an object on a screen; reading a second predefined text expected to be input next to the first predefined text from a predetermined storage device, on the condition that input of the first predefined text has been determined by the button being pushed; and displaying the read second predefined text as an input candidate on the button.

Furthermore, the present invention can be regarded as a program for causing a computer to realize the functions of: referring to scenario information that defines multiple predefined texts that are to be input candidates for a predetermined processing along with relationships between each of the predefined texts and a predefined text expected to be input next to the predefined text; and displaying a first predefined text that has been defined by the scenario information, as an input candidate, and subsequently, on the condition that input of the first predefined text has been determined, displaying a second predefined text as an input candidate defined by the scenario information to be input next to the first predefined text.

### BRIEF DESCRIPTION OF THE DRAWINGS

FIG. 1 shows an exemplary hardware configuration of a mobile information terminal to which the present invention may be applied.

FIGS. 2A and 2B show an example of a screen display of a mobile information terminal according to the present invention.

FIG. 3 shows exemplary functional configuration of a mobile information terminal according to the present invention.

FIGS. 4A and 4B describe scenario information.

FIG. 5 is a flowchart showing exemplary processing according to an embodiment of the invention.

FIG. 6 shows transitions among screens of the mobile information terminal.

FIG. 7 shows an exemplary functional configuration of a mobile information terminal according to a second embodiment of the invention.

FIGS. 8A and 8B describe scenario information used in the second embodiment.

FIG. 9 is a flowchart showing exemplary processing operations according to the second embodiment.

FIG. 10 shows transitions among screens of a mobile information terminal, according to the second embodiment.

FIG. 11 is a flowchart showing a process for registering scenario information used in the second embodiment.

FIGS. 12A and 12B describe a process for registering scenario information used in the second embodiment.

### DETAILED DESCRIPTION

An embodiment of the present invention will be described below in detail with reference to the accompanying drawings.

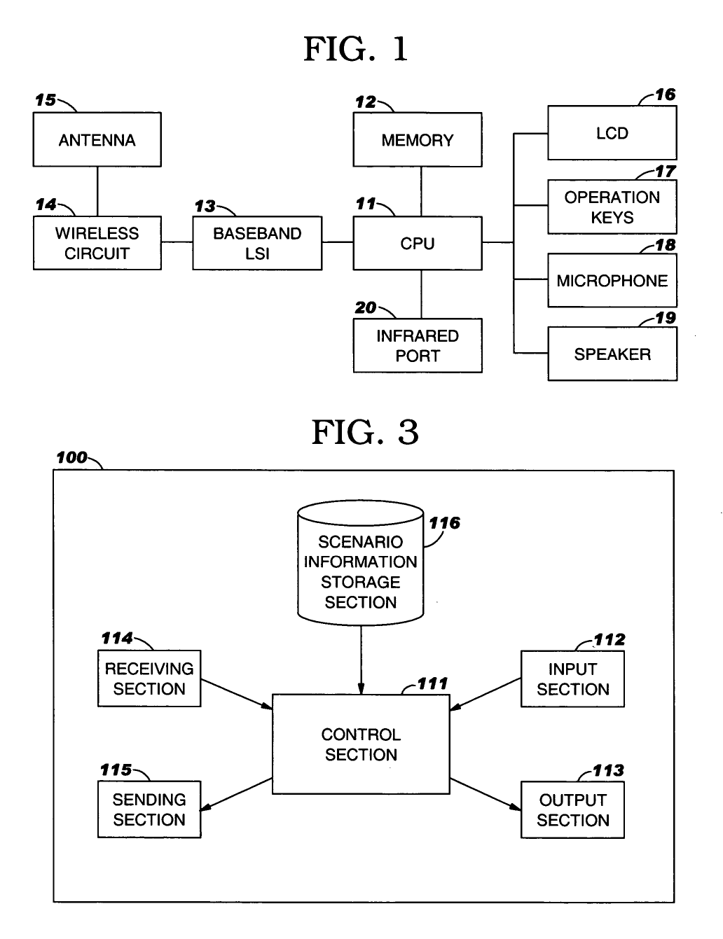

FIG. 1 schematically shows an example of a hardware configuration suitable for realizing a mobile information terminal 100 according to a first embodiment of the present invention.

The exemplary terminal, which is illustrated as a mobile phone as shown in FIG. 1, is provided with a CPU (central processing unit) 11 which includes arithmetic means, a memory 12 which includes storage means, a baseband LSI 13 for performing signal processing, a wireless circuit 14 and an antenna 15 for performing wireless communication via a base station, an LCD (liquid crystal display) 16 for input/output controlled by the CPU 11, an operation keys 17, a microphone 18, a speaker 19, and an infrared port 20 for performing infrared communication with other computers. FIG. 1 is illustrative rather than limiting, however, and various other configurations may also be used.

Memory 12 stores a computer program for realizing each of the functions of this embodiment. The functions of this embodiment, to be described later, may be realized by way of the CPU 11 reading and executing this computer program. The computer program may be stored in the memory 12 prior to shipment of the mobile phone, or may be installed by a user after shipment of the mobile phone. Methods for installing the computer program such as downloading it from a sever computer via wireless communication, using a recording medium such as an SD card, and the like, all fall within the scope of the present description.

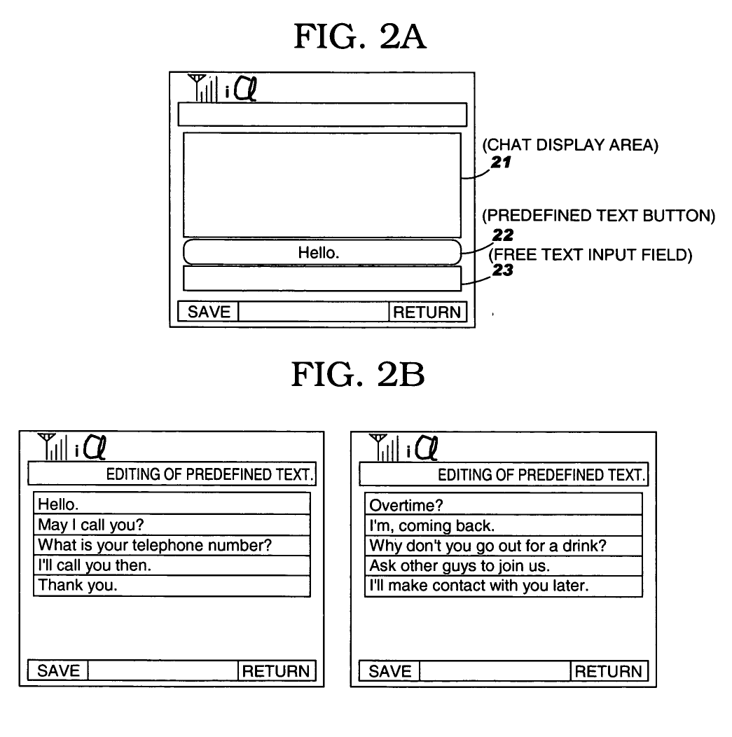

The contents to be displayed on the LCD 16 of the mobile phone in this embodiment will now be described with reference to FIGS. 2A and 2B.

FIG. 2A shows an exemplary display in the context of chatting over a mobile phone. A chat display area 21, a predefined text button 22, and a free text input field 23 are displayed. The chat display area 21 is an area in which the contents of the chat are displayed in order of time.

The predefined text button 22 may be an object on a screen that is designed to activate the sending of a message when it is pushed. For example, the operation of pushing the button can be performed by clicking a mouse button in the case of a personal computer. In the case of a mobile phone, which is not provided with a mouse, the operation may be performed by pushing the upward key or the downward key to position the cursor at the button to select the button, and then pushing the center key to signal the selection. In this embodiment, a message may be displayed as a label of the button. When the button is pushed, the message is handed to the sending function and sent.

The free text input field 23 is an area used when sending a freely described message without the use of a predefined text.

In the case of a chat session in a business situation, the purposes of the various messages can be assumed to some extent. For example, one may confirm attendance prior to making an inquiry when he or she is away from the office. In this case, after confirmation of attendance and a little chat, the bulk of the conversation is often carried on orally using the telephone. In such a brief chat exchange, the flow of messages can be anticipated to some extent. Accordingly, in this embodiment, the flow of the conversation to be performed is registered as scenario information that includes a chain of predefined texts.

FIG. 2B shows a predefined text registration screen for registering such predefined text. The screen on the left side is for registering a scenario used for the case where one confirms attendance when he or she is away from the office to talk about the main issue orally by telephone. It is also possible to register not just this one scenario, but also those used for different cases such as the scenario shown on the right side.

This embodiment will now be separated into a first embodiment and a second embodiment according to the types of scenarios to be registered, and described below in detail.

The first embodiment is for the case where the scenario information illustrated on the predefined text registration screen of FIG. 2B is registered. FIG. 3 shows an exemplary functional configuration of a mobile phone according to this embodiment. As shown in FIG. 3, this embodiment comprises a control section 111, an input section 112, an output section 113, a receiving section 114, a sending section 115, and a scenario information storage section 116.

The control section 111 includes means for controlling the input section 112, the output section 113, the receiving section 114, and the sending section 115. The input section 112 includes means for communicating information input by the operation keys 17 to the control section 111. The output section 113 communicates the information communicated by the control section 111 to output means such as the LCD 16. The receiving section 114 communicates information received via the antenna 15, the wireless circuit 14, and the baseband LSI 13, to the control section 111. The sending section 115 includes means for communicating the information communicated by the control section 111 to the baseband LSI 13.

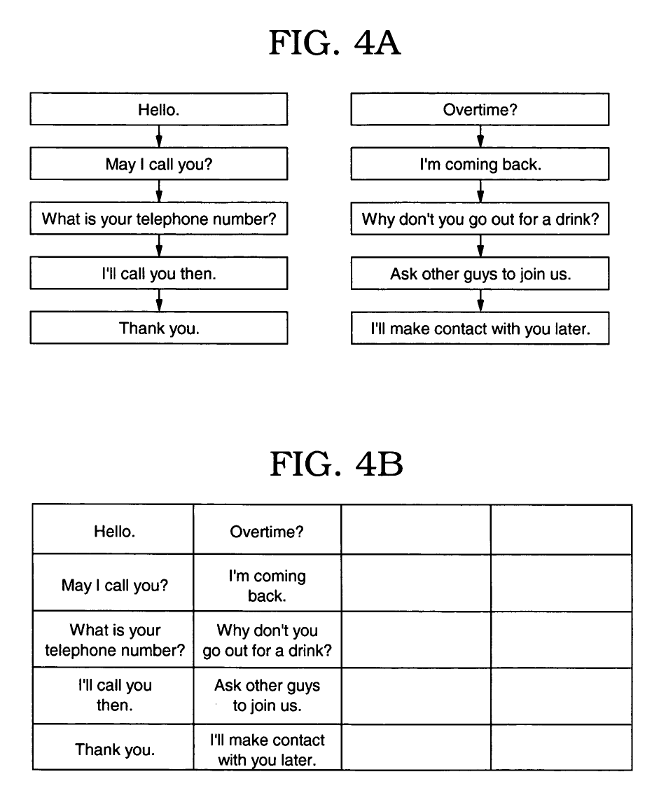

The scenario information storage section 116 includes means for storing scenario information, which information will be now described with reference to FIG. 4.

FIG. 4A schematically shows exemplary scenario information. That is, the scenario information on the left side shows that the predefined text expected to be sent following “Hello” is “May I call you?”; the predefined text expected to be sent next is “What is your telephone number?”; the predefined text expected to be sent next is “I'll call you then”; and the predefined text expected to be sent next is “Thank you.” The scenario information on the right side shows that the predefined text expected to be sent following “Overtime?” is “I'm coming back”; the predefined text expected to be sent next is “Why don't you go out for a drink?”; the predefined text expected to be sent next is “Ask other guys to join us”; and the predefined text expected to be sent next is “I'll make contact with you later.”

Any method may be used for storing the scenario information shown in FIG. 4A in the scenario information storage section 116, provided only that the predefined texts included in each scenario and the order of the predefined texts can be identified. For example, a matrix-type storage area as shown in FIG. 4B may be prepared to store each of the predefined texts in each cell. In this case, the order of the predefined texts is represented by the vertical arrangement of the cells in a particular column of the matrix.

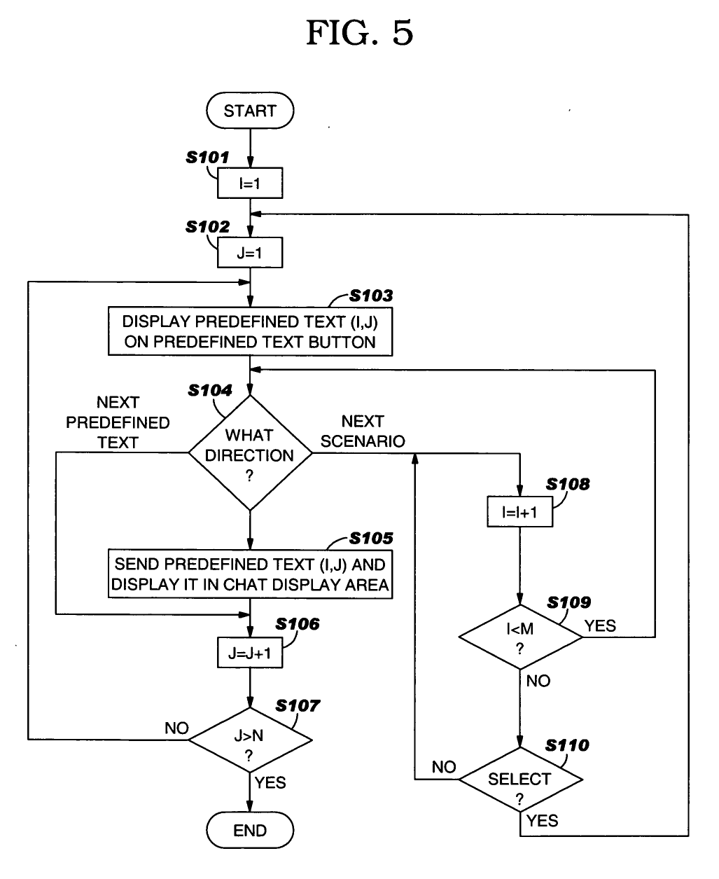

The operation of this embodiment will be now described in detail with reference to FIG. 5. In this description of the operation, the J-th predefined text of the I-th scenario is represented as a predefined text (I, J). For example, if the storage method as shown in FIG. 4B is adopted, the predefined text (I, J) indicates the predefined text stored in the cell in the I-th column and in the J-th row.

The control section 111 sets “1” for a variable I which counts scenarios (step 101) and “1” for a variable J which counts predefined texts in a scenario (step 102). Then, the predefined text (I, J) is read from the scenario information storage section 116, and a predefined text button 22 having the predefined text as a label is communicated to the output section 113 so that the predefined text button 22 is displayed on the LCD 16 (step 103).

The control section 111 then receives a command by the operation keys 17 from the input section 112 and determines the contents of the command (step 104).

As a result, if it is determined that sending the predefined text displayed on the label of the predefined text button 22 has been directed, then the predefined text is communicated to the sending section 115 and displayed in the chat display area 21 (step 105). The process then proceeds to step 106. The predefined text communicated to the sending section 115 is sent to the counterpart's computer via the baseband LSI 13, the wireless circuit 14, and the antenna 15.

If it is determined to display the next predefined text on the label of the predefined text button 22 without sending the predefined text displayed on the predefined text button 22, then the process proceeds to step 106 without performing the processing of step 105.

The control section 111 adds “1” to the variable J (step 106) and determines whether or not the variable J has exceeded N, the number of predefined texts defined by the scenario (step 107). If the variable J has exceeded N, then the process ends. If the variable J has not exceeded N, then the process returns to step 103.

If change to the next scenario is directed at step 104, then “1” is added to the variable I (step 108), and it is determined whether or not the variable I has exceeded M, the number of scenarios defined in the scenario information storage section 116 (step 109). If the variable I has exceeded M, the process returns to step 104. If the variable I has not exceeded M, then the user is queried as to whether or not to select the scenario (step 110). If the user does not select the scenario, the process proceeds to step 108. If the user selects the scenario, then the process returns to step 102 and performs the subsequent processing for the scenario.

It is also possible to provide a route for subtracting “1” from the variable J and then proceeding to step 103 if the resulting value of J is less than “1” in the case where it is determined at step 104 that it has been directed to display the immediately preceding predefined text on the label of the predefined text button 22. Furthermore, it is also possible to provide a route for subtracting “1” from the variable I and then proceeding to step 102 if the resulting value of the variable I is not less than “1” and the scenario is selected, in the case where change to the immediately preceding scenario is directed at step 104.

Furthermore, though the process ends when the determination at step 107 is “YES” in FIG. 5, the process may return to step 103 after setting “1” for the variable J. Furthermore, as processing to be performed when directed to display the immediately preceding predefined text on the label of the predefined text button 22 at step 104, the process may end or proceed to step 103 after setting “N” for the variable J when the variable J is less than “1”.

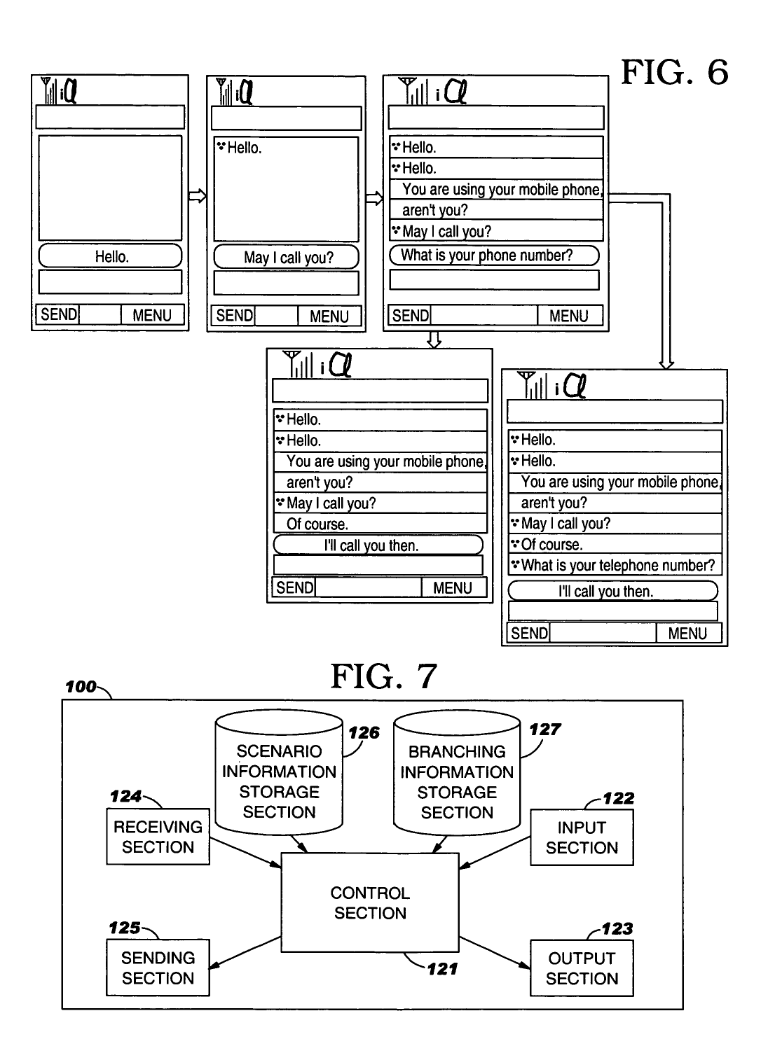

The operation of this embodiment will be specifically described below using the transition of screens shown in FIG. 6.

The left-hand side of FIG. 4A is assumed to be a scenario corresponding to “I=1” and the right-hand side is assumed to be a scenario corresponding to “I=2”. It is also assumed that it is possible to direct the predefined text immediately before the predefined text to be displayed on the predefined text button 22 by pushing “4” of the operation keys 17 and to direct the predefined text immediately after the predefined text to be displayed on the predefined text button 22 by pushing “6” of the operation keys 17. Furthermore, it is assumed that the scenario immediately before the scenario currently used can be set for use by pushing “*” of the operation keys 17 and that the scenario immediately after the scenario currently used can be set for use by pushing “#” of the operation keys 17.

The variable I is set to “1” at step 101, and “1” is set for the variable J at step 102. At step 103, “Hello,” which is a predefined text (1, 1), is displayed on the predefined text button 22.

When the predefined text button 22 is pushed, it is determined at step 104 that the command is to perform sending, and therefore, “Hello,” displayed on the predefined text button 22, is sent and displayed in the chat display area 21 at step 105. At the same time, “2” is set for the variable J at step 106. At step 107, it is determined that the variable J has not exceeded “5”, the number of predefined texts, and therefore, at step 103, “May I call you?”, which is the predefined text (1, 2), is displayed on the predefined text button 22.

When sending the predefined text “May I call you?” in response to the reply from the counterpart, the user pushes the predefined text button 22. From this, it is determined at step 104 that the command is to perform sending, and therefore, at step 105, “May I call you?”, which is displayed on the predefined text button 22, is sent and displayed in the chat display area 21. At the same time, “3” is set for the variable J at step 106. At step 107, it is determined that the variable J has not exceeded “5”, the number of predefined texts, and therefore, “What is your telephone number?”, which is the predefined text (1, 3), is displayed on the predefined text button 22.

When sending the predefined text “What is your telephone number?” in response to the reply from the counterpart, the user pushes the predefined text button 22. From this, it is determined that at step 104 the command is to perform sending, and therefore, at step 105, “What is your telephone number?”, which is displayed on the predefined text button 22, is sent and displayed in the chat display area 21. At the same time, “4” is set for the variable J at step 106. At step 107, it is determined that the variable J has not exceeded “5”, the number of predefined texts, and therefore, at step 103, “I'll call you then” which is the predefined text (1, 4) is displayed on the predefined text button 22.

It is now assumed that the predefined text “What is your telephone number?” is not sent in response to the reply from the counterpart. For example, when the counterpart's telephone number is already known, this happens. In this case, the user pushes the “6” key. From this, it is determined at step 104 that the command is to display the next predefined text, and therefore, “What is your telephone number?”, which is displayed on the predefined text button 22, is neither sent nor displayed in the chat display area 21. After that, “4” is set for the variable J at step 106. At step 107, it is determined that variable J has not exceeded “5”, the number of predefined texts, and therefore, “I'll call you then” which is the predefined text (1, 4) is displayed on the predefined text button 22.

The above process is repeated until it is determined at step 107 that the variable J has exceeded “5”, the number of predefined texts.

During any of the states of the screens, if the user wants to move to the scenario shown on the right side of FIG. 4A, he or she pushes the “#” key. From this, it is determined at step 104 that the direction is to change to the next scenario, and therefore, at step 108, “2” is set for the variable I. It is determined at step 109 that the variable I has not exceeded the number of scenarios, and therefore, at step 110, the setting of the scenario is changed by the user selecting the scenario. It is also possible to return the scenario setting to the original state by the user pushing the “*” key during the above mentioned condition.

The second embodiment is for the case where scenario information that includes branching information is registered.

FIG. 7 shows an exemplary functional configuration of a mobile phone according to this embodiment. As shown in FIG. 7, this embodiment comprises a control section 121, an input section 122, an output section 123, a receiving section 124, a sending section 125, a scenario information storage section 126, and a branching information storage section 127.

The control section 121 includes means for controlling the input section 122, the output section 123, the receiving section 124, and the sending section 125. The input section 122 includes means for communicating information input by the operation keys 17 to the control section 121. The output section 123 communicates the information from the control section 121 to output means such as the LCD 16. The receiving section 124 communicates information received via the antenna 15, the wireless circuit 14, and the baseband LSI 13, to the control section 121. The sending section 125 includes means for communicating the information from the control section 121 to the baseband LSI 13.

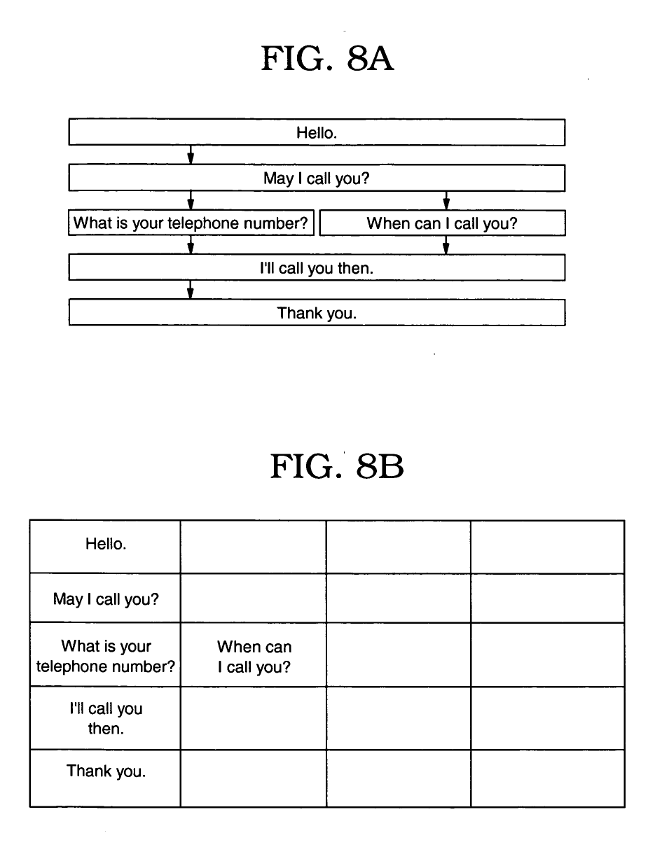

The scenario information storage section 126 includes means for storing scenario information, which scenario information will be now described with reference to FIGS. 8A and 8B.

FIG. 8A schematically shows scenario information. That is, it shows that the predefined text expected to be sent after “Hello” is “May I call you?” Two options are provided for the predefined text expected to be sent. In this example, they are “What is your telephone number?” and “When can I call you?” The predefined text expected to be sent next is “I'll call you then”; and the predefined text expected to be sent next is “Thank you”.

Any method may be used for storing the scenario information shown in FIG. 8A in the scenario information storage section 126, provided only that the multiple predefined texts included in each scenario and the order of the predefined texts can be identified. For example, a matrix-type storage area as shown in FIG. 8B may be prepared to store each of predefined texts in each cell. In this case, the order of the predefined texts is expressed by the vertical arrangement of the cells in a particular column of the matrix. In the case where there are multiple options as the predefined text expected to be sent following a particular predefined text, these options are stored in the cells in the same row on the matrix.

However, predefined texts in the cells in the same row on the matrix may not necessarily be candidates for the predefined text to be sent following a particular predefined text. Therefore, in this embodiment, the branching information storage section 127 is also provided. The branching information storage section 127 manages which predefined texts, among the predefined texts stored in the cells in the same row, correspond to the multiple branched options based on information for associating the predefined texts with one another.

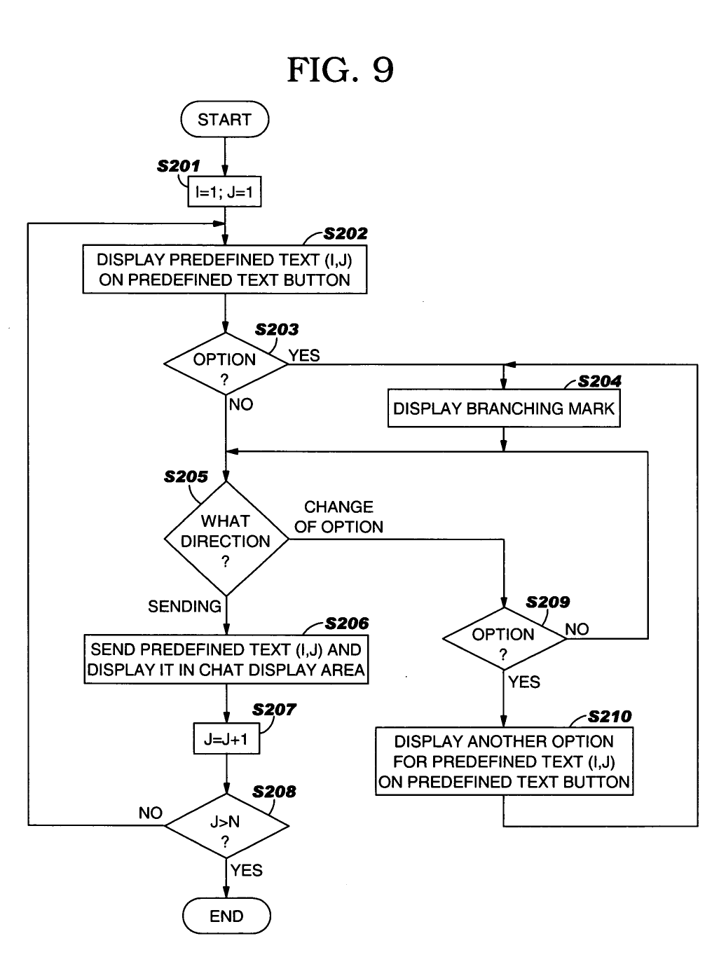

The operation of this embodiment will be now described with reference to FIG. 9. In this description of the operation, the J-th predefined text of the I-th scenario is again represented as a predefined text (I, J). However, in this embodiment, multiple branched options may be provided for the predefined text (I, J). For example, if the storage method as shown in FIG. 8B is adopted, then the predefined text (1, 3) is “What is your telephone number?” and “When can I call you?”. In this case, the simple description of a predefined text (I, J) is assumed to indicate any one of the multiple options.

The control section 121 sets “1” for the variable I which counts scenarios and “1” for the variable J which counts predefined texts in a scenario (step 201). Then, the predefined text (I, J) is read from the scenario information storage section 126, and a predefined text button 22 having the predefined text as a label is communicated to the output section 123 so that the predefined text button 22 is displayed on the LCD 16 (step 202).

In this case, the control section 121 determines whether or not the predefined text (I, J) is one of the multiple branched options (step 203). If it is one of the multiple options, then a branching mark is also displayed on the predefined text button 22 (step 204). The control section 121 then receives an indication by the operation keys 17 from the input section 122 and determines the contents of the direction (step 205).

As a result, if it is determined that sending the predefined text displayed on the label of the predefined text button 22 has been directed, then the predefined text is communicated to the sending section 125 and displayed in the chat display area 21 (step 206). The predefined text communicated to the sending section 125 is sent to the counterpart's computer via the baseband LSI 13, the wireless circuit 14, and the antenna 15. The control section 121 then adds “1” to the variable J (step 207) and determines whether or not the variable J has exceeded N, the number of predefined texts defined by the scenario (step 208). If the variable J has exceeded N, the process ends. If the variable J has not exceeded N, then the process returns to step 202.

If change of the option is directed at step 205, then it is determined whether or not the predefined text displayed on the predefined text button 22 is one of the multiple branched options (step 209). Specifically, it is checked whether or not information for associating the predefined text with other predefined texts is managed in the branching information storage section 127. If the predefined text is not one of the multiple options, then the direction is invalid and the process returns to step 205. If the predefined text is one of the multiple options, then the branching information storage section 127 is referred to, and a predefined text which is any other option among the multiple options corresponding to the predefined text (I, J) is identified and displayed on the predefined text button 22. In this case, since the predefined text displayed on the predefined text button 22 is one of the multiple options, a branching mark is displayed (step 204), and the process proceeds to step 205.

Although, in FIG. 9, the process ends if the determination at step 208 is “YES”, the process may return to step 202 after setting “1” for the variable J.

Furthermore, in this embodiment, movement to the predefined text before or after the predefined text displayed on the predefined text button 22 or change to any other scenario may be performed in response to a predetermined direction similarly to the first embodiment.

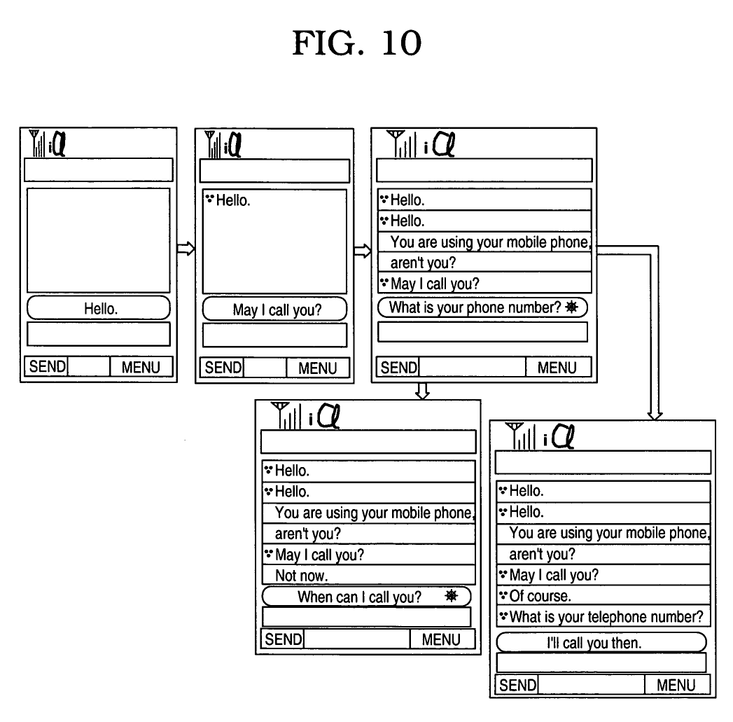

The operation of this embodiment will be now described using the transition of screens shown in FIG. 10. Here, the scenario shown in FIG. 8A is assumed to be a scenario corresponding to “I=1”. It is also assumed that it is possible to direct change from the predefined text displayed on the predefined text button 22 to a predefined text under any other option by pushing “5” of the operation keys 17.

At step 201, “1” is set for the variable I and for the variable J. At step 202, “Hello”, which is the predefined text (1, 1), is displayed on the predefined text button 22. In this case, at step 203, it is determined that the predefined text (1, 1) is not one of the multiple options, and therefore, step 204 is not performed.

Then, responsive to pushing the predefined text button 22, it is determined at step 205 that the command is to perform sending, and therefore, “Hello”, displayed on the predefined text button 22, is sent and displayed in the chat display area 21 at step 206. At the same time, “2” is set for the variable J at step 207. At step 208, it is determined that the variable J has not exceeded “5”, the number of predefined texts, and therefore, at step 202, “May I call you?” which is the predefined text (1, 2) is displayed on the predefined text button 22. In this case, at step 203, it is determined that the predefined text (1, 2) is not one of the multiple options, and therefore, step 204 is not performed.

When sending the predefined text “May I call you?” in response to the reply from the counterpart, the user pushes the predefined text button 22. From this, it is determined that the command is to perform sending at step 205, and therefore, at step 206, “May I call you?”, which is displayed on the predefined text button 22, is sent and displayed in the chat display area 21. At the same time, “3” is set for the variable J at step 207. At step 208, it is determined that the variable J has not exceeded “5”, the number of predefined texts, and therefore, at step 202, “What is your telephone number?” which is one of the predefined texts (1, 3) is displayed on the predefined text button 22. In this case, at step 203, it is determined that the predefined text (1, 3) is one of the multiple options, a branching mark is displayed on the predefined text button 22.

When sending the predefined text “What is your telephone number?” in response to the reply from the counterpart, the user pushes the predefined text button 22. From this, it is determined at step 205 that the command is to perform sending, and therefore, at step 206, “What is your telephone number?”, which is displayed on the predefined text button 22, is sent and displayed in the chat display area 21. At the same time, “4” is set for the variable J at step 207. At step 207, it is determined that the variable J has not exceeded “5”, the number of predefined texts, and therefore, at step 202, “I'll call you then” which is the predefined text (1, 4) is displayed on the predefined text button 22.

Assume now that it is suitable to send a predefined text “When can I call you?” rather than the predefined text “What is your telephone number?” in response to the reply from the counterpart. In this case, the user pushes the “5” key. From this, it is determined at step 205 that the command is to change the option, and therefore, the process proceeds to step 209. Then, it is determined that “What is your telephone number?” displayed on the predefined text button 22 is one of the multiple options, and therefore, at step 210, “When can I call you?”, another option among the multiple options, is displayed on the predefined text button 22. At step 204, a branching mark is also displayed on the predefined text button 22.

The above process is repeated until it is determined at step 208 that the variable J has exceeded “5”, the number of predefined texts.

Though specific description has been made only on the case where there are two branched options in this embodiment, the same goes for the case where there are more than two branched options. In this case, by giving the order to the multiple options, the options can be displayed in accordance with the order.

In the first and second embodiments described above, FIG. 4B and FIG. 8B have been described only as examples of a method for storing scenario information. Description will be now made of a process for registering a predefined text to each cell in the case where such a storage method is adopted.

In the case of the example shown in FIG. 4B, predefined texts can be simply registered sequentially from the top of the cell in a particular column in accordance with a scenario.

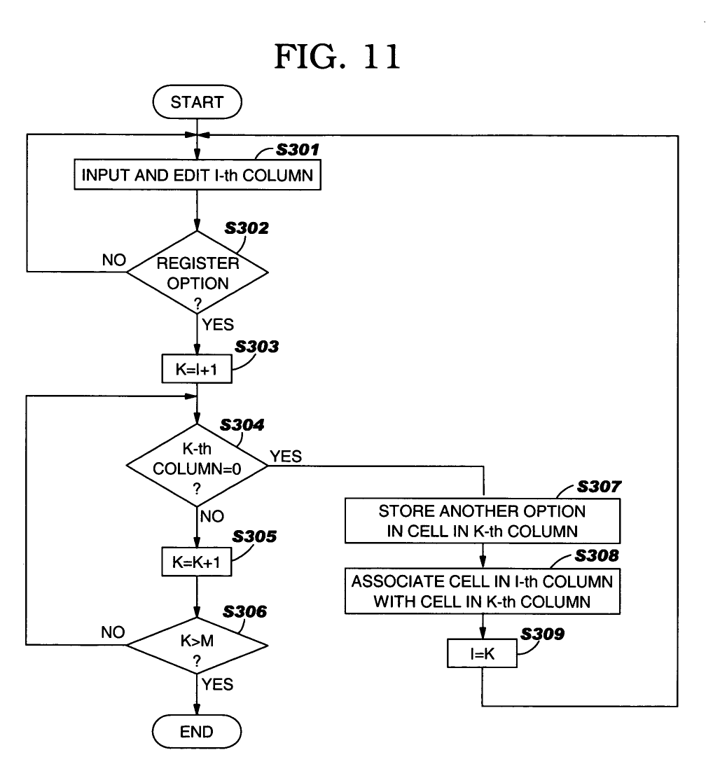

FIG. 11 shows the operations in registering another option for a predefined text being input and edited in the I-th column. In the description of this operation, it is assumed that a predefined text is registered with a matrix formed with N rows and M columns, and the cell located in the I-th column and in the J-th row is represented by a cell (I, J).

A scenario information registration section (not shown) performs input and editing for the I-th column of the matrix stored in the scenario information storage section 126 (step 301) and determines whether or not registration of another option has been directed (step 302).

If registration of another option has not been directed, then the process returns to step 301. If registration of another option has been directed, then the process proceeds to step 303. In this case, it is assumed that, with the predefined text stored in the cell (I, J) regarded as one option, registration of another option has been directed.

In response to this, the scenario information registration section sets “I+1” for a variable K used as a counter for searching for a column in which that other option should be stored (step 303) and determines whether the K-th column is empty (step 304). If it is determined that the K-th column is not empty, then “1” is added to the variable K (step 305) and it is determined whether K has exceeded M (step 306). If K has exceeded M, then the process ends, and otherwise the process returns to step 304. After repeating this process, if it is determined at step 304 that the K-th column is empty, then that other option is stored in the cell (K, J) (step 307) and stores information for associating the cell (I, J) and the cell (K, J) with each other in the branching information storage section 127 (step 308). Then, the value of the variable K is set for the variable I (step 309), and the process returns to step 301. That is, input and editing for the K-th column is performed.

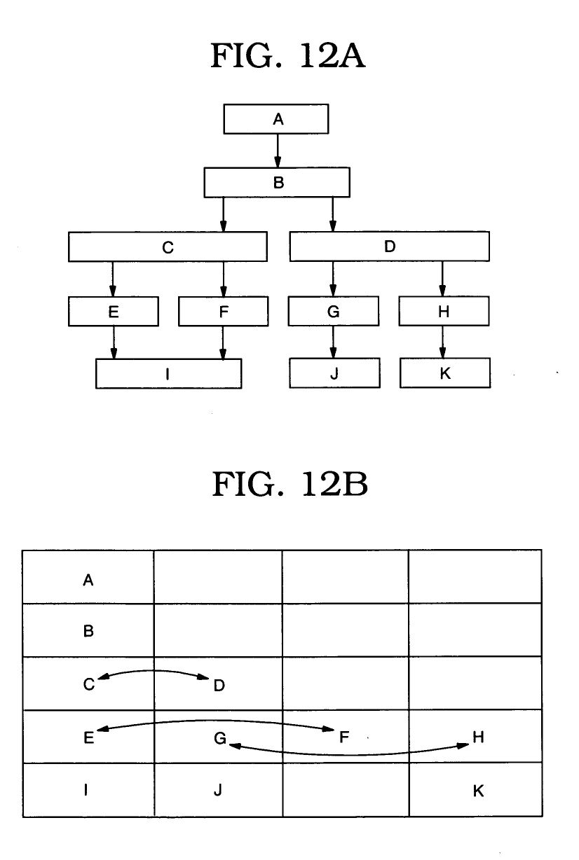

This operation will be specifically described below. The case will be discussed where a scenario as shown in FIG. 12A is stored in a matrix, for example.

First, if the user thinks of a straight flow of “A”®“B”®“C”®“E”®“I” when no scenario is stored in the matrix, then the scenario is stored in the first column of the matrix as shown in FIG. 12B. That is, the operation of FIG. 11 in the case of “I=1” is started, and input and editing for the first column are performed at step 301.

Assume that the user thinks of an option “D” in addition to “C” as a predefined text following “B” and directs registration thereof by pushing a “branching button,” for example. That is, it is assumed that registration of another option with the cell (1, 3) has been directed.

In this case, it is determined at step 302 that registration of another option has been directed; “2” is set for the variable K at step 303; and it is determined at step 304 that the second column is empty. Accordingly, “D” is stored in the cell (2, 3) at step 307, and information for associating the cell (1, 3) and the cell (2, 3) with each other is stored in the branching information storage section 127 at step 308. Then, at step 309, “2” is set for the variable I, and the process returns to step 301. Then, input and editing for the second column is performed. For example, the user directs registration of predefined texts “G” and “J” following “D”, these predefined texts are stored in the cell below “D”.

The case will be now discussed where the first column is edited again. It is assumed that the operation of FIG. 11 in the case of “I=1” has been started again, and input and editing for the first column is being performed at step 301.

Assume now that the user thinks of “F” in addition to “E” as a predefined text following “C” and directs registration thereof by pushing the “branching button,” for example. That is, it is assumed that registration of another option with the cell (1, 4) has been directed.

In this case, it is determined at step 302 that registration of another option has been directed, and “2” is set for the variable K at step 303, but it is not determined at step 303 that the second column is empty. Accordingly, “3” is set for the variable K at step 305. Since it is determined at step 306 that the variable K has not exceeded “4”, the process returns to step 304, where it is determined that the third column is empty. Accordingly, “F” is stored in the cell (3, 4) at step 307, and at step 308, information for associating the cell (1, 4) and the cell (3, 4) with each other is stored in the branching information storage section 127. Then, at step 309, “3” is set for the variable I, and the process returns to step 301. Then, input and editing for the third column is performed. Since there is no predefined text following “F”, the cells below “F” are left empty.

The case will be now discussed where the second column is edited. That is, the operation of FIG. 11 in the case of “1=2” is started, and input and editing for the second column are performed at step 301.

Assume that the user thinks of an option “H” in addition to “G” as a predefined text next to “D” and directs registration thereof by pushing the “branching button,” for example. That is, it is assumed that registration of another option with the cell (2, 4) has been directed.

In this case, it is determined at step 302 that registration of another option has been directed, and “3” is set for the variable K at step 303, but it is not determined at step 304 that the third column is empty. Accordingly, “4” is set for the variable K at step 305. Since it is determined at step 306 that the variable K has not exceeded “4”, the process returns to step 304, where it is determined the fourth column is empty. Accordingly, “H” is stored in the cell (4, 4) at step 307, and information for associating the cell (2, 4) and the cell (4, 4) with each other is stored in the branching information storage section 127 at step 308. Then, at step 309, “4” is set for the variable I, and the process returns to step 301. Then, input and editing for the fourth column is performed. For example, if the user directs registration of a predefined text “K” following “H”, then the predefined text is stored in the cell below “H”.

Though, in the above description, association among predefined texts forming multiple branched options is performed by the branching information storage section 127 separate from the scenario information storage section 126, each cell of the matrix in the scenario information storage section 126 may be provided with an attribute for association.

Although, in the above embodiment, description has been given of the case where the present invention is applied to a chat system, the present invention is applicable to any process wherein input candidates and the order thereof can be assumed in advance.

Furthermore, this embodiment can be realized in equipment other than a mobile phone. In this case, the operation of pushing the button on which a predefined text is displayed can be performed with whatever method is commonly used for pushing a button in that type of equipment.

1. An input support apparatus, comprising:
a storage section for storing scenario information that defines multiple predefined texts that are input candidates along with relationship between each of the predefined texts and a predefined text expected to be input following the predefined text; and
a display section for displaying a first predefined text that has been defined by the scenario information, as an input candidate, and subsequently, on a condition that input of the first predefined text has been determined, displaying a second predefined text as an input candidate defined by the scenario information to be input following the first predefined text.

2. The input support apparatus according to claim 1, wherein the display section displays the first predefined text on a button that is an object on a screen and determines that input of the first predefined text has been selected by detecting the button being pushed.

3. The input support apparatus according to claim 1, wherein, if a predetermined operation other than the operation of determining input of the first predefined text is performed while the first predefined text is displayed, then the display section displays the second predefined text or a third predefined text defined to be input immediately before the first predefined text.

4. The input support apparatus according to claim 1, wherein
the storage section stores multiple pieces of the scenario information; and
if, while a predefined text defined by first scenario information among the multiple pieces of scenario information is displayed, a predetermined operation other than the operation of determining input of the displayed predefined text is performed, then the display section displays a predefined text defined by second scenario information among the multiple pieces of the scenario information.

5. The input support apparatus according to claim 1, wherein the storage section stores, as the scenario information, a matrix in which each of the multiple predefined texts is stored in each cell such that the cell in which each predefined text is stored and the cell in which a predefined text expected to be input next to the predefined text adjoin each other.

6. The input support apparatus according to claim 1, wherein, if there is any other predefined text defined by the scenario information as being expected to be input next to the first predefined text, in addition to the second predefined text, then the display section displays the second predefined text and information indicating that there is a predefined text defined to be input next to the first predefined text in addition to the second predefined text, on the condition that input of the first predefined text has been determined.

7. The input support apparatus according to claim 1, wherein, if there is a fourth predefined text defined by the scenario information as being expected to be input following a particular predefined text in addition to the first predefined text, and a predetermined operation other than the operation of determining input of the first predefined text is performed while the first predefined text is displayed, then the display section displays the fourth predefined text.

8. The input support apparatus according to claim 7, wherein the storage section stores, as the scenario information, a matrix in which each of the multiple predefined texts is stored in each cell such that the cell in which each predefined text is stored and the cell in which a predefined text expected to be input following the predefined text adjoin each other and further stores branching information for associating a cell in which a predefined text expected to be input following a particular predefined text and a cell in which a different predefined text expected to be input following the particular predefined text with each other.

9. A message sending apparatus, comprising:
a display section for displaying a button to which a message expected to be sent next is attached; and
a sending section for, when the button displayed on the display section is pushed, sending the message attached to the button.

10. The message sending apparatus according to claim 9, wherein the display section displays, when the message is sent by the sending section, a button to which another message to be sent following the sent message is attached.

11. The message sending apparatus according to claim 10, wherein the display section displays, when the message is sent by the sending section, the sent message in a predetermined area different from the button.

12. A user interface, comprising:
a button on which a message expected to be sent next is displayed as a label; and
an area in which the message displayed on the button as a label is displayed when the button is pushed.

13. An input support method, comprising the steps of:
displaying a first predefined text as an input candidate on a button that is an object on a screen;
reading a second predefined text expected to be input following the first predefined text from a predetermined storage device, on the condition that input of the first predefined text has been determined by the button being pushed; and
displaying the read second predefined text as an input candidate on the button.

14. The input support method according to claim 13, wherein, if there is stored any other predefined text expected to be input following the first predefined text, in addition to the second predefined text, then the displaying step displays the second predefined text and information indicating that there is a predefined text defined to be input following the first predefined text in addition to the second predefined text, on the condition that input of the first predefined text has been determined by the button being pushed.

15. A program for causing a computer to realize the functions of:
referring to scenario information that defines multiple predefined texts that are to be input candidates for a predetermined processing along with relationship between each of the predefined texts and a predefined text expected to be input following the predefined text; and
displaying a first predefined text that has been defined by the scenario information, as an input candidate, and subsequently, on the condition that input of the first predefined text has been determined, displaying a second predefined text as an input candidate defined by the scenario information to be input following the first predefined text.

16. The program according to claim 15, wherein the displaying function displays the first predefined text on a button that is an object on a screen and determines that input of the first predefined text has been determined by detecting the button being pushed.

17. The program according to claim 15, wherein, if a predetermined operation other than the operation of determining input of the first predefined text is performed while the first predefined text is displayed, then the displaying function displays the second predefined text or a third predefined text defined to be input immediately before the first predefined text.

18. The program according to claim 15, wherein
the referring function refers to multiple pieces of the scenario information; and
if, while a predefined text defined by first scenario information among the multiple pieces of scenario information is displayed, a predetermined operation other than the operation of determining input of the displayed predefined text is performed, then the displaying function displays a predefined text defined by second scenario information among the multiple pieces of the scenario information.

19. The program according to claim 15, wherein, if there is any other predefined text defined by the scenario information as being expected to be input following the first predefined text, in addition to the second predefined text, then the displaying function displays the second predefined text and information indicating that there is a predefined text defined to be input following the first predefined text in addition to the second predefined text, on the condition that input of the first predefined text has been determined.

20. The program according to claim 15, wherein, if there is a fourth predefined text defined by the scenario information as being expected to be input following a particular predefined text, in addition to the first predefined text, and a predetermined operation other than the operation of determining input of the first predefined text is performed while the first predefined text is displayed, then the display section displays the fourth predefined text.
